(19) United States
(12) Patent Application Publication
(10) Pub. No.: US 2011/0029332 A1
(43) Pub. Date: Feb. 3, 2011

(54) METHOD AND SYSTEM FOR GUARANTEEING REPAIR OF A DAMAGED WINDSHIELD

(75) Inventors: Denis Hugron, St-Hubert (CA); Jean-Paul Aubin, Ste-Julie (CA)

Correspondence Address: BCF LLP, 1100 RENE'-LE'VESQUE BLVD. WEST, 25TH FLOOR, MONTREAL, QC, H3B-5C9, CA

(73) Assignee: SUPER VITRE INC., St-Hubert, QC (CA)

(21) Appl. No.: 12/680,226

(22) PCT Filed: Sep. 27, 2007
(86) PCT No.: PCT/CA2007/001746

§ 371 Date: Oct. 15, 2010

(51) Int. Cl. G06Q 40/00

(52) U.S. Cl. 705/4

(57) ABSTRACT

A method and system for guaranteeing a plurality of windshields against damages that can be repaired through a windshield guarantee program is provided, wherein the guarantee program is managed by an administrator. Through a windshield identification code and a vehicle dealer identification code, each guaranteed windshield is associated to a vehicle dealer. In counterpart of a premium paid by the owner of the vehicle, the windshield is fully guaranteed against damages that can be repaired. Upon the occurrence of a damage to a guaranteed windshield, the damaged windshield can be repaired at the related vehicle dealer. The premium can be calculated according to windshield casualty data such as rate of damages, nature of damages, and costs for repairing stored in a database.

### FIELD

The present invention generally relates to a guarantee program for guaranteeing windshields against damages that can be repaired. More specifically, but not exclusively, the present invention is concerned with a windshield guarantee program managed by an administrator, whereby a damaged windshield that can be repaired is taken care of at a vehicle dealer, typically at the vehicle dealer where the car comprising the damaged windshield was bought.

### BACKGROUND

A vehicle's windshield being damaged is not an uncommon event. For example, damage to the windshield of a vehicle can be caused by a flying piece of debris, such as a stone initially lying on a roadway and subsequently projected by the motion of a wheel of another vehicle. The resulting damage can be, for example, a bull's eye, a star, or a fissure, and the damaged windshield either can be repaired or replaced.

Because the cost of replacing a damaged windshield is generally more expensive than the cost of repairing it, the damaged windshield is likely to be repaired if it is possible and safe to do so. Typical procedures for repairing windshields are believed to be known to those of ordinary skill in the art.

When a windshield that is covered by an insurance policy emitted by an insurer undergoes damage, the beneficiary of the insurance policy, i.e. the insured, can claim to the insurer the costs for repairing or replacing the damaged windshield. Typically, the insured communicates with the insurer and the latter suggests the former a list of vehicle repair centers where to have the damaged windshield either repaired or replaced. It is to be noted that typically, the vehicle repair centers are not vehicle dealers.

From the suggested list, the owner will choose a vehicle repair center; the chosen vehicle repair center will take care of the repair or replacement of the damaged windshield as well as make arrangements with the insurer to get paid, entirely or partially. In the latter case, the insured will assume the difference.

Generally, the insurer prefers that a damaged windshield be repaired since the costs of replacing a windshield is significantly higher than repairing it. For example, the costs of replacing a damaged windshield can be as high as ten times the cost of repairing it. This is a major reason why the insurer typically pays in total the costs of repairing a damaged windshield, without charging the insured any deductible. Indeed, if an insured is charged a deductible for repairing a damaged windshield, or worse, if he has to pay in total the costs of repairing the damaged windshield, it is likely that he will neglect to do so. Consequently to this eventual negligence, it is expected that the damage on the windshield will evolve to a point where it cannot be repaired. As a result, the damaged windshield will have to be replaced instead of being repaired, and the insurer will bear the largest portion of the replacement costs, i.e. the total replacement costs minus a deductible.

Thus, the insurer is likely to give its clients an incentive to diligently act when a windshield needs to be repaired, the incentive being reflected in the insurer's charging no deductible for a damaged windshield to be repaired.

Nonetheless, the insurer still has to support high administrative costs for processing a settlement for repairing a windshield. Typically, an insurer has to pay an additional administrative cost higher than the cost of repair. Thus, insurers are still looking for solutions to decrease the additional administrative costs.

For this reason, the insurer tends to choose vehicle repair centers having the lowest costs for repairing damaged windshields, the vehicle repair centers being typically not vehicle dealers. Although this way to proceed presents indeed an advantage to the insurer, it can comprise at least two drawbacks for the insured. First, a vehicle repair center is less knowledgeable of the vehicle than the vehicle dealer from which the vehicle originates and, as such, has less expertise to take care of a damaged windshield; and second, in the case where the damaged windshield has to be replaced, the vehicle repair center typically will not use a genuine windshield as a replacement windshield, thus inducing problems such as undue stress in the replacement windshield or leakage therearound as a result of a tedious fitting arising from the replacement windshield's parameters not being exactly those of the vehicle's manufacturer.

Typically, from the point of view of the insured, the insurance premium of the latter will not increase after only one claim for repairing a damaged windshield; however, the occurrence thereof is reported to the insured record at the insurer and, after a given number of claims during a given period of time, for windshield repairs alone or in combination with claims of other types, the insurer will increase the insurance premium to be paid by the insured. This, of course, constitutes a drawback to the insured since it is possible for the insurance premium to increase as a result of a claim for repairing a damaged windshield. As a consequence, the insured might delay the repair of a damaged windshield, either to avoid an insurance premium increase or a disbursement of money, the latter case arising from the insured's deciding not to claim the repair of the windshield to the insurer.

As a matter of fact, it is believed that about ninety percent (90%) of the replacements of damaged windshields occur as a result of a fissure that was initially repairable but that evolved into a damage that is not reparable anymore, as a result of neglecting to repair the damage in due time.

Also, in an effort to keep cost down, the insurer will typically ask its personnel to be strict when they process claims for damaged windshields, therefore adding the extra burden to the insured of having difficulty to get a settlement with the insurer.

Finally, the facts that insurers force their insured to have, when necessary, windshield repairs or replacements carried out at specific vehicle repair centers reflect in less business for vehicle dealers where the vehicles of the insured have been originally bought.

Therefore, the conventional procedure for handling a damaged windshield gives rise to drawbacks to the insured, the insurer and the vehicle dealer where the vehicle was originally bought since the insured might see the premium increase after a claim and might be serviced by a non-dealer vehicle repair service; the insurer incurs high repair and/or replacement costs; and the vehicle dealer looses business as the repair and/or replacement is performed by another non-dealer vehicle repair center.

### SUMMARY

According to the present invention, there is provided a method and system for guaranteeing the repair a damaged windshield.

More specifically, according to the present invention, there is provided a method for guaranteeing the repair of a damaged windshield through a guarantee program, wherein at least one vehicle dealer participates to the guarantee program and a plurality of windshields are guaranteed by the guarantee program each in exchange of a premium paid by an owner of a vehicle equipped with the windshield, the method inducing the owners of the guaranteed windshields to have repairs made at the at least one participating vehicle dealer. The method comprises: providing a processing unit having a data storage device associated therewith; assigning to each of the at least one vehicle dealer a corresponding vehicle dealer identifying code; for each of the at least one vehicle dealer, storing the corresponding vehicle dealer identifying code in the data storage device; assigning to each of the plurality of windshields a corresponding windshield identifying code; for each of the plurality of windshields, storing the corresponding windshield identifying code in the data storage device; and relating each of the plurality of windshields to a vehicle dealer by relating the corresponding windshield identifying code to a corresponding vehicle dealer identifying code. Therefore, the owners of the guaranteed windshields are induced to have guaranteed windshields repaired for free at the at least one participating vehicle dealer, thereby increasing participating vehicle dealer traffic.

The present invention also relates to a system for guaranteeing the repair of a damaged windshield through a guarantee program, wherein at least one vehicle dealer participates to the guarantee program and a plurality of windshields are guaranteed by the guarantee program each in exchange of a premium paid by an owner of a vehicle equipped with the windshield, the system inducing the owners of the guaranteed windshields to have repairs made at the at least one participating vehicle dealer. The system comprises a processing unit so configured as to: assign to each of the at least one vehicle dealer a corresponding vehicle dealer identifying code; assign to each of the plurality of windshields a corresponding windshield identifying code; and relate each windshield to a vehicle dealer by relating the corresponding windshield identifying code to the corresponding vehicle dealer identifying code. The system also comprises a storage device associated with the processing unit, the storage device being so configured as to: store the corresponding vehicle dealer identifying code for each of the at least one vehicle dealer; store the corresponding windshield identifying code for each of the plurality of windshields; and store the relation between the windshield identifying code of each of the plurality of windshields and the corresponding vehicle dealer identifying code of the at least one vehicle dealer. Therefore, the owners of guaranteed windshields are induced to have the guaranteed windshields repaired for free at the at least one participating vehicle dealer, thereby increasing participating vehicle dealer traffic.

The present invention is further concerned with a method for guaranteeing the repair of a damaged windshield through a guarantee program, wherein a plurality of windshields are guaranteed by the guarantee program each in exchange of a premium paid by an owner of a vehicle equipped with the windshield, the method comprising: providing a processing unit having a data storage device associated therewith; assigning to each of the plurality of windshields a corresponding windshield identifying code; for each of the plurality of windshields, storing the corresponding windshield identifying code in the data storage device; storing in the data storage device serial numbers of the vehicles equipped with the plurality of windshields; and relating each of the plurality of windshields to the vehicle equipped with the windshield by relating the windshield identifying code of the windshield to the serial number of the vehicle equipped with that windshield. Upon repairing a damaged windshield, the guarantee of the damaged windshield being repaired can be validated through validation of the serial number of the vehicle equipped with that damaged windshield.

Still further in accordance with the present invention, there is provided a system for guaranteeing the repair of a damaged windshield through a guarantee program, wherein a plurality of windshields are guaranteed by the guarantee program each in exchange of a premium paid by an owner of a vehicle equipped with the windshield, the system comprising a processing unit so configured as to: assign to each of the plurality of windshields a corresponding windshield identifying code; relate each of the plurality of windshields to the vehicle equipped with the windshield by relating the windshield identifying code of the windshield to a serial number of the vehicle equipped with that windshield. The system also comprises a storage device associated with the processing unit, the storage device being so configured as to: store the windshield identifying codes of the plurality of windshields; store serial numbers of the vehicles equipped with the plurality of windshields; and store the relation between the windshield identifying code of each of the plurality of windshields and the serial number of the vehicle equipped with the windshield. Upon repairing a damaged windshield, the guarantee of the damaged windshield being repaired can be validated through validation of the serial number of the vehicle equipped with said damaged windshield.

In the present specification and the appended claims, the terms <<dealer>> and <<vehicle dealer>> are intended to designate any corporate body, company, partnership, society, moral person, physical person, individual, etc. that sells and services vehicles of a single or many makes. The terms <<dealer>> and <<vehicle dealer>> are also intended to designate a vehicle manufacturer. The terms <<dealer>> and <<vehicle dealer>> are further intended to designate, as a whole, a vehicle manufacturer and the network of vehicle dealers involved in the sale and servicing of the vehicles produced by the vehicle manufacturer as a whole. Please keep in mind that the above list is not restrictive.

It is to be noted that the use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The foregoing and other objects, advantages and features of the present invention will become more apparent upon reading of the following non-restrictive description of an illustrative embodiment thereof, given by way of example only, with reference to the accompanying drawings.

### BRIEF DESCRIPTION OF THE DRAWINGS

In the appended drawings:

FIG. 1 is a schematic diagram showing a pool of vehicles, the windshields of each being guaranteed by a guarantee program according to an illustrative embodiment of the present invention;

FIG. 2 schematically illustrates the various players in the guarantee program and their possible interactions;

FIG. 3 shows a guarantee program system used by an administrator to manage a guarantee program according to an illustrative embodiment of the present invention, wherein the guarantee program system comprises a data storage device and a processing unit, the processing unit being linked to terminals;

FIG. 4 is a diagram illustrating how to relate a windshield to a vehicle dealer by relating a windshield identifying code, corresponding to the windshield, to a vehicle dealer identifying code, corresponding to the vehicle dealer;

FIG. 5 is a flow chart of a method for registering a windshield in the guarantee program;

FIG. 6 shows a sticker emitted when a windshield is registered in the guarantee program;

FIG. 7 is a flow chart of an interaction between the insurer and the guarantee program system while the insurer performs a verification of the eligibility of a vehicle; and

FIG. 8 is a flow chart of a method for processing a claim for repairing a windshield according to the guarantee program.

### DETAILED DESCRIPTION

A method and system for guaranteeing repair of a damaged windshield according to a non-restrictive illustrative embodiment of the present invention will now be described.

Generally stated, the method and system according to the non-restrictive illustrative embodiment described hereinbelow are concerned with assigning a windshield identifying code to each windshield part of the guarantee program, and with assigning a vehicle dealer identifying code to each vehicle dealer part of the guarantee program. Thereby, a vehicle owner reporting damage to a windshield part of the program directly or indirectly to a system administrator may be directed to a corresponding vehicle dealer for guaranteed repair, thereby insuring the quality of the service and parts and increasing the vehicle dealer traffic.

In the non-restrictive illustrative embodiment, only damaged windshields that are repairable are considered. A damaged windshield can be part of any type of vehicle, such as a car, a van, a truck or a bus.

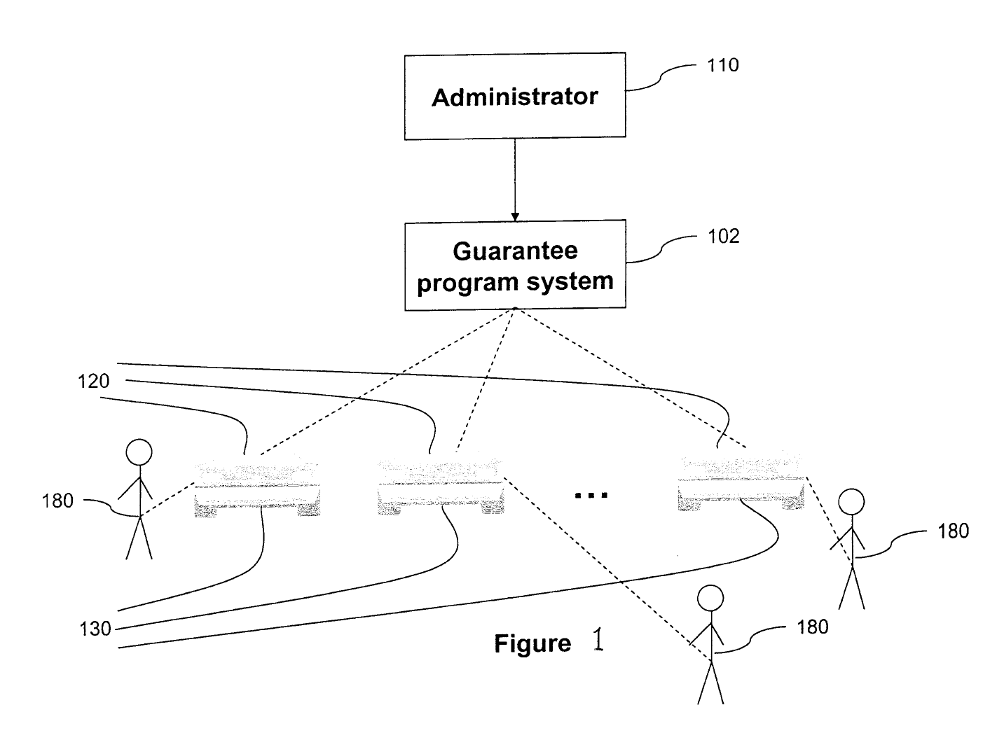

Referring now to FIG. 1 of the appended drawings, a guarantee program system 102 for carrying out a guarantee program is managed by an administrator 110. The purpose of the guarantee program is to cover a plurality of windshields 120 for potential repair costs resulting from damages made thereon. Each windshield 120 corresponds to a vehicle 130, which is owned by a corresponding owner 180. It has to be noted that the owner 180 can be either a physical or a moral person.

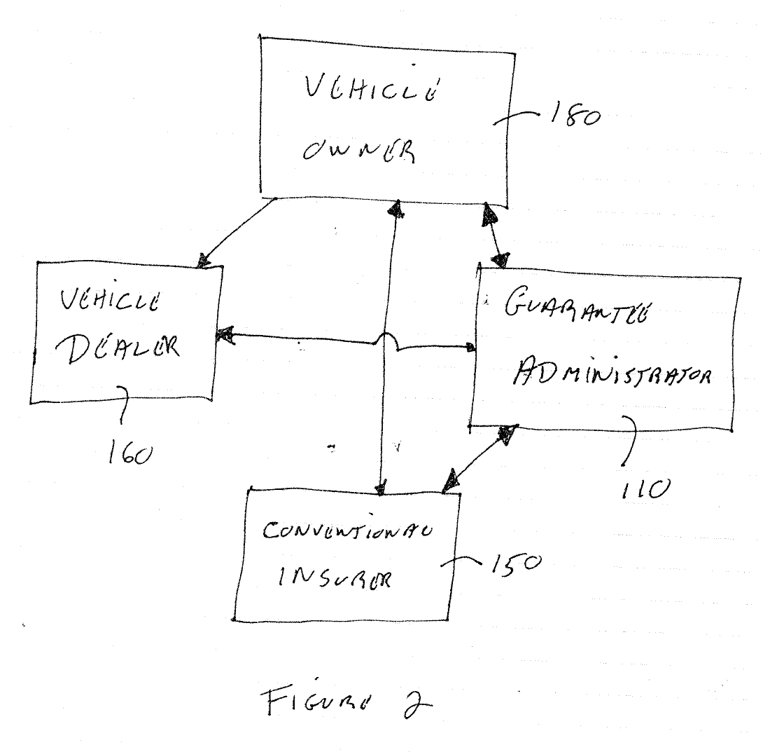

FIG. 2 of the appended drawings, schematically illustrates the various players and their interaction. As will be explained in greater details hereinbelow, when a vehicle owner 180 has a damaged windshield protected by the guarantee program, he may go directly to the vehicle dealer 160 that sold the vehicle to the owner 180 to get a free repair. If he is not aware that the windshield is protected by the guarantee program, he may go to the conventional insurer 150 that will refer the owner 180 to the guarantee administrator 110 that will, in turn, refer him to the vehicle dealer 160 or to another vehicle dealer if necessary. A third option is for the owner 180 to contact the guarantee administrator 110 directly to be referred to the vehicle dealer 160 or to another vehicle dealer.

The participating vehicle dealer 160 is one that has a technical expertise in respect of the makes of vehicles that are related thereto, and advantageously uses genuine parts, for example when a windshield 120 cannot be repaired and has to be replaced.

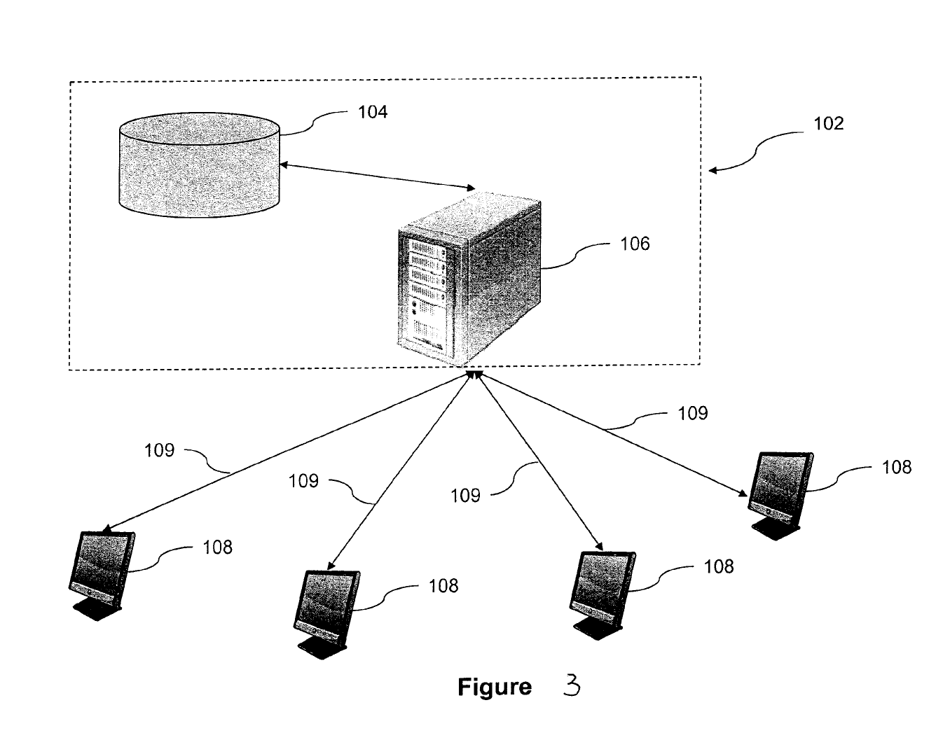

Referring now to FIG. 3, the guarantee program system 102 comprises a data storage device 104, a processing unit 106, and terminals 108 connected to the processing unit 106 via links 109 that can be dedicated or part of a network such as the internet. The terminals 108 may be dedicated terminals or personal computers running an adequate program.

It is to be noted that the data storage device 104, which is associated with the processing unit 106, is not necessarily situated at the same location as the processing unit 106.

On the one hand, some of the terminals 108 are deployed at the vehicle dealers to exchange data, i.e. inputting, retrieving or displaying, between the vehicle dealers and the data storage device 104. On the other hand, other terminals 108 are deployed at the insurers and can be used by the latter for verifying in databases of the data storage device 104 whether windshields of particular vehicles are covered by the guarantee program.

In order to exchange data with the guarantee program system 102, each of the participating vehicle dealers and the participating insurers has an account in the guarantee program system 102 that can be accessed from a terminal 108 by using a proper user login and password. It is believed within the reach of those skilled in the art to deploy a system accessible, for example from a web site, via a login and a password.

The data storage device 104 contains many databases. The casualty statistics are stored in a first database. The casualty statistics of the first database comprises casualty data underlying damages to windshields of vehicles, such as:
type of windshield casualties;
rates of occurrence of damages to windshields;
nature of damages to windshields;
costs of repairing windshields; and
combinations of the above data.

A second database of the data storage device 104 comprises information related to the vehicle dealers 160 participating in the guarantee program 100, such as, for each vehicle dealer 160, a vehicle dealer identifying code and the coordinates of the vehicle dealer.

A third database of the data storage device 104 comprises information related to insurers, such as, for each insurer, an insurer identifying code, the coordinates of the insurer, the types of insurance policies that are offered thereat.

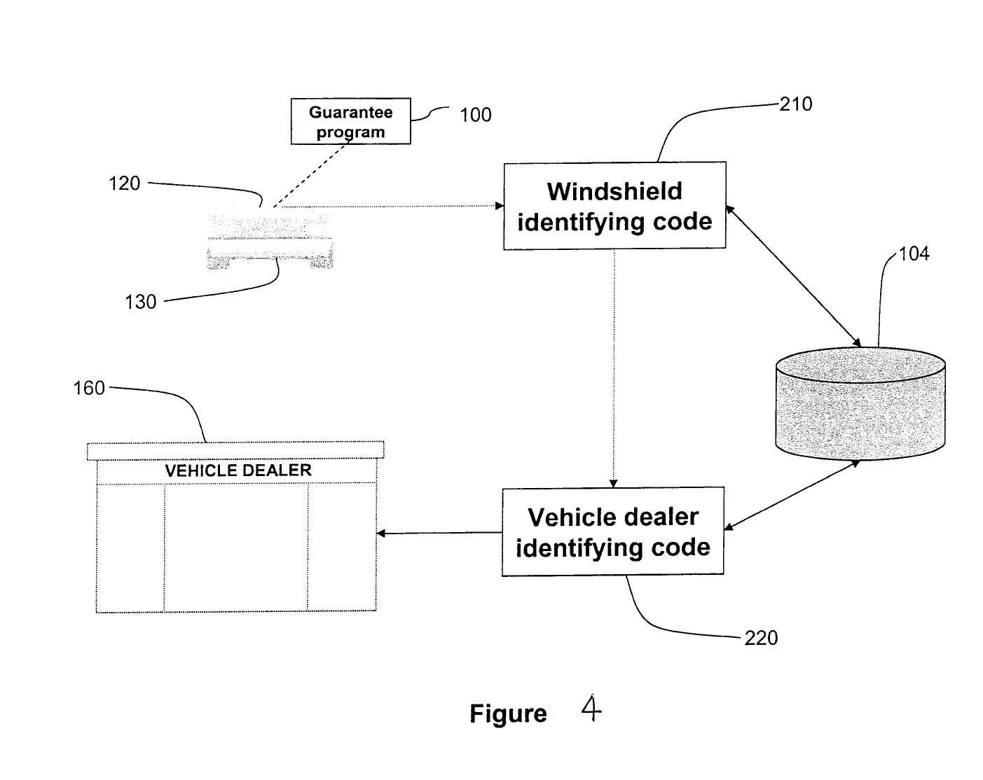

Referring now to FIG. 4, each windshield 120 that becomes covered by the guarantee program is related to a windshield identifying code 210. Likewise, each windshield identifying code 210 is related to a vehicle dealer identifying code 220, which in turn is related to a vehicle dealer 160. Data regarding the windshield 120, the windshield identifying code 210 related to the windshield 120, the vehicle dealer identifying code 220 related to the windshield identifying code 210, the vehicle dealer 160 related to the vehicle dealer identifying code 220, the vehicle 130 equipped with the windshield 120 and the owner 180 of the vehicle 130 are stored in a fourth database of the data storage device 104.

According to one aspect of the non-restrictive, illustrative embodiment, the serial number of the vehicle 130 can be used as the windshield identifying code.

### Windshield Registration

Many types of windshield registration are possible. The windshield of new vehicles can be registered when the vehicle is sold, the vehicle dealer may sell the guarantee program after the vehicle is sold, and used vehicles can also be registered by the dealer. For example, when the windshield of a client's vehicle is repaired or replaced by the service department of a participating vehicle dealer, the repaired or new windshield can be registered in the guarantee program.

To register a vehicle into the guarantee program, each vehicle dealer 160 has access to a terminal 108.

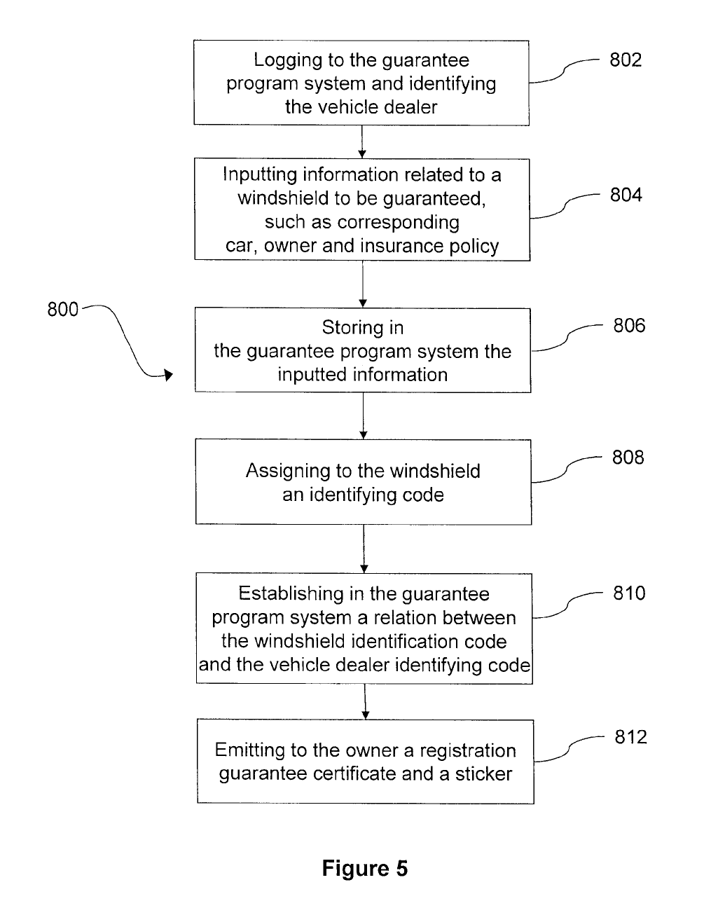

The processing unit 106 is advantageously programmed so as to embody a method for registering a windshield in the guarantee program and to establish relations between the windshield 120, the corresponding windshield identifying code 210, the vehicle dealer identifying code 220, and vehicle dealer 160, as will now be described with reference to FIG. 5.

The first step in the registration process consists in logging in the system (step 802). This is done via one of the terminals 108. The vehicle dealer is identified by the guarantee program system 102 through a recognition software installed in the terminal 108. More specifically, the guarantee program system 102 will recognize the hard disk of a terminal 108 on which that recognition software has been installed.

Then, in step 804, information pertaining to the vehicle 130 comprising the windshield 120, the owner 180, and, if the case occurs, the conventional insurance policy covering the windshield 120 of the vehicle 130 is entered in the guarantee program system 102. For example, such information can comprise: the make, year, color, serial number and other specifications of the vehicle 130; the name and address of the owner; and the insurance policy number and the name of the insurer covering the vehicle 130. This will allow, for example but not exclusively, to relate the identifying code of the windshield 120 to the serial number of the corresponding vehicle to prevent use of the sticker and corresponding windshield identifying code to obtain free repair of the windshield of another vehicle of which the windshield is not guaranteed.

The inputted information about the vehicle 130 is then stored in the data storage device 104 (step 806).

Then, in step 808, the processing unit 106 and the databases of the data storage device 104, are used to assign a windshield identifying code 210 to the windshield 120.

The relation between the windshield identifying code 210 and the vehicle dealer identifying code 220 is then established and stored in the data storage device 104 (step 810).

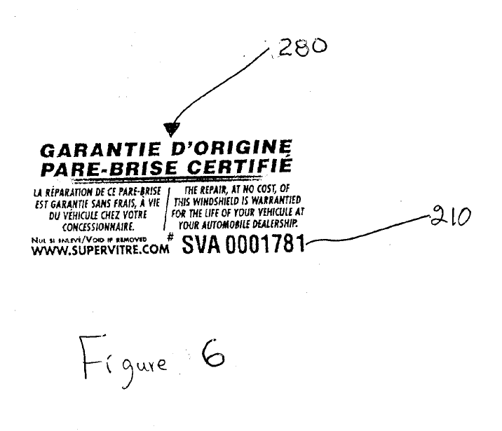

Finally, step 812 consists in emitting to the owner 180 a registration guarantee certificate and a sticker 280. An example of a possible sticker 280 is shown in FIG. 6.

Of course, the steps of the method 800 can be repeated as many times as there are windshields to be registered in the guarantee program.

FIG. 6, shows a sticker 280 emitted at step 812 of the method 800. Typically, the sticker 280 bears the windshield identification code 210, and is to be affixed to the windshield 120. The sticker 280 serves as a proof that the windshield 120 is covered by the guarantee program 100.

The guarantee certificate can comprise, for example, the windshield identification code 210, the vehicle dealer identification code 220, and the phone number or internet address for getting assistance, if necessary.

Typically, but not exclusively, the guarantee certificate and the sticker 280 are emitted on the spot by the vehicle dealer, which is one that is knowledgeable of the make of the vehicle and that can provide genuine parts, i.e. windshields, thereof. Typically, but not exclusively, the vehicle dealer is the one that originally sold the vehicle or one that sells the same vehicle make as that of the vehicle.

### Windshield Repair

Depending on the awareness of the owner regarding the guarantee program, there are several paths that can be taken when damage to the windshield is discovered by the owner.

If the owner is fully aware of the guarantee program, the vehicle dealer may be contacted directly for guaranteed repairs.

If the owner is not aware, or has forgotten, that the windshield is registered to the guarantee program, the owner conventionally contacts the conventional insurer that may verify in the guarantee program system 102 via a terminal 108 that the windshield is registered. If it is so, the insurer may refer the vehicle owner to the appropriate vehicle dealer.

In other words, if the insurer participates to the guarantee program 100, then the insurer will check whether the owner has registered the windshield to the guarantee program. If this is the case, and if the damaged windshield is deemed to be repairable, then the insurer will ask the owner to have the guaranteed damaged windshield repaired at the corresponding vehicle dealer and the insurer will not pay for the costs of repairing the damaged windshield since the windshield is already covered by the guarantee program. The vehicle dealer will, upon request from the owner, repair the damaged windshield at no costs to the owner. It is to be noted that the insurer may also direct the vehicle owner to another vehicle dealer if necessary.

The processing unit 106 is advantageously programmed so as to embody a method for allowing an insurer to perform a query for verifying the eligibility of a vehicle, i.e. if the vehicle is registered to the program 100 by finding, for example, the serial number of the vehicle. The insurer is identified by the guarantee program system 102 through a recognition software installed in the corresponding terminal 108. More specifically, the guarantee program system 102 will recognize the hard disk of a terminal 108 on which that recognition software has been installed.

Of course, to use this method the insurer has to log in, using a login name and password, to be identified as a participating insurer.

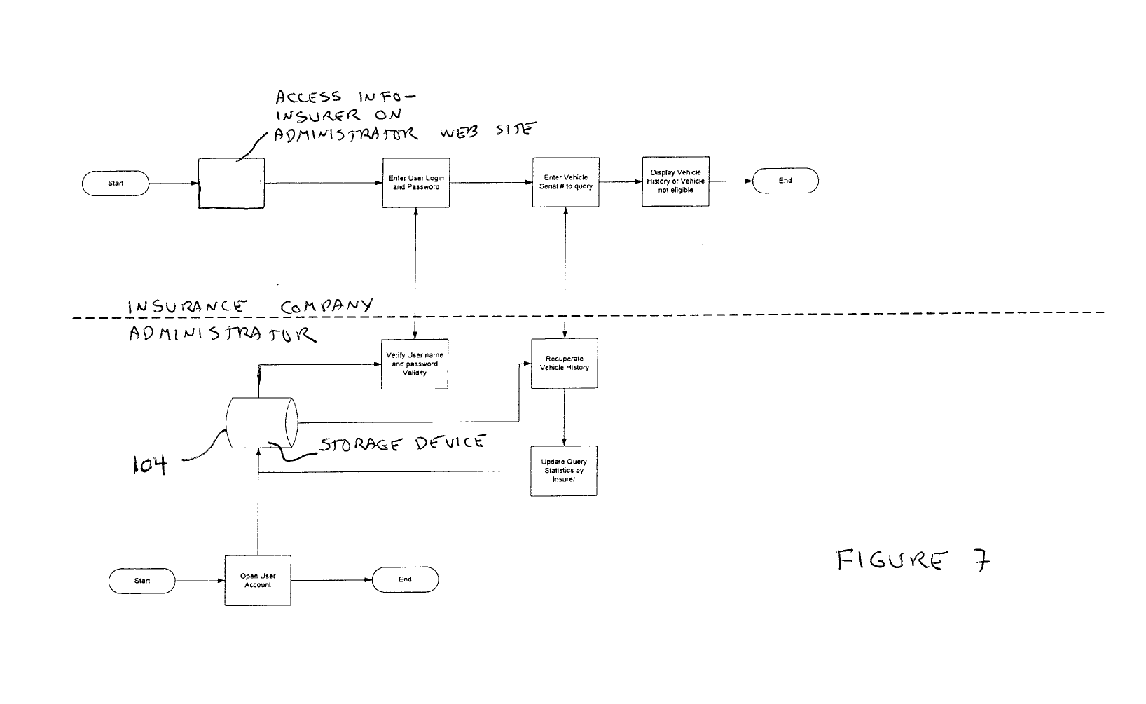

FIG. 7 shows a diagrammatic view of the interaction between the insurer and the guarantee program system 102 while the insurer performs a verification of the eligibility of a vehicle and its windshield.

Ultimately, when a guaranteed windshield 120 is damaged, the owner 180 presents the sticker 280 eventually along with a corresponding warranty certificate to the vehicle dealer 160.

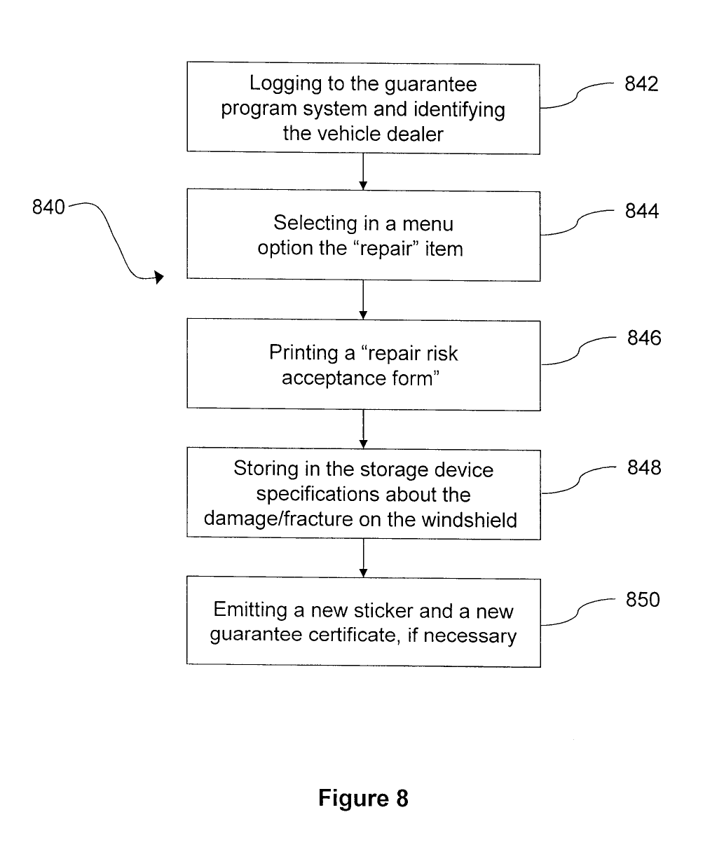

The processing unit 106 is advantageously programmed so as to embody a method for processing a claim for repairing a windshield, as will now be described with reference to FIG. 8.

First, in step 842, the terminal of the vehicle dealer is used to log into the guarantee program system 102. The vehicle dealer is identified by the guarantee program system 102 through a recognition software installed in the terminal 108. More specifically, the guarantee program system 102 will recognize the hard disk of a terminal 108 on which that recognition software has been installed.

Then, in step 844, a “repair” item is selected from a menu option.

A “repair risk acceptance form” is printed in step 846. The purpose of the “repair risk acceptance form” is for the owner 180 to accept a risk that following an attempt to repair it, the windshield 120 might become not repairable anymore, i.e. the windshield can crack during the repair.

In step 848, the particulars about the damage/fracture on the windshield 120 are then stored in the storage device 104 for future reference.

Finally, in step 850, a new sticker 280 and a new guarantee certificate are printed if necessary, i.e. if the windshield has been replaced. In the case where the windshield 120 is not repairable, and the latter is replaced by a new windshield at the vehicle dealer 160, then the new windshield is registered in the guarantee program 100, according to the method described hereinabove, with an history of the windshield 120 available in the data storage 104.

It should be noted that whether the windshield 120 is covered by an insurance policy of an insurer or not, the insurer is not involved in the processing of the claim.

In the non-restrictive, illustrative embodiment, the fact that a windshield 120 is associated to a car dealer 160 constitutes an incentive for car dealers to enter into the guarantee program 100.

It has to be noted that the owner of a vehicle provided with a guaranteed windshield having a damage that seems repairable will be induced to go to a participating vehicle dealer first to have the windshield repaired. If the damaged windshield is not repairable, the owner will likely decide to have the damaged windshield replace by the vehicle dealer, since the owner is already there: advantageously, this results in the windshield's being replaced with genuine parts and vehicle dealer's increased business and traffic. Then, the cost for replacing the windshield will be paid, in a usual manner, at least in part by the insurer.

Furthermore, the fact that the identifying code of the windshield 120 can be related to the serial number of the corresponding vehicle will prevent fraudulent use of the sticker and corresponding windshield identifying code to obtain free repair of the windshield of another vehicle of which the windshield is not guaranteed.

### Financial Aspects

The guarantee program according to the present non-restrictive illustrative embodiment is based on the fact that not all covered windshields will incur damage. For example, it is generally recognized that about 10% of all windshields are repaired each year and that about 5% of all windshields are replaced each year. If the annual total damage costs are equally distributed between the owners of a large pool of vehicles, the premium amount for such a guarantee is quite low.

It is believed that it is within the reach of those skilled in the art to determine a premium for covering the windshields by the guarantee program, according to pertaining casualty statistics as contained in a database of the data storage device 104. Indeed, as will be apparent to those of ordinary skill in the art, the processing unit 106 can be advantageously programmed so as to embody a method for calculating the premium to be paid for registering a windshield in the guarantee program.

It is to be noted that the premium can be charged, either only once, annually or at any other frequency or upon the occurrence of a particular event.

According to a first alternative, the guarantee program fully covers the costs for repairing a damaged windshield for the entire useful life of the vehicle, in counterpart of a sole payment of the premium by the owner. It is to be understood that, according to a second alternative, it is possible to consider a guarantee program with any combination of the following: the costs for repairing a damaged windshield are only partially covered, there are more than one payment for a windshield to be covered, and a windshield is covered for less than the useful life of the corresponding vehicle.

According to one aspect of the non-restrictive illustrative embodiment, the premium is included in the vehicle's sale price upon sale of the latter by the vehicle dealer.

According to another aspect of the non-restrictive illustrative embodiment, the owner pays the premium to the vehicle dealer for his currently owned vehicle so as to enter the guarantee program.

Typically, in any of the above two aspects of the non-restrictive illustrative embodiment described hereinabove, the premium is paid once over the lifetime of the vehicle by the owner and is collected by the vehicle dealer. A first portion of the collected premium is remitted to the guarantee administrator in counterpart of the administrator's managing the guarantee program. A second portion of the collected premium is used by the vehicle dealer to constitute an actuarial reserve so as to secure future claims made to the vehicle dealer in respect to damaged windshield covered by the guarantee program. A third portion can eventually be cashed by the vehicle dealer as revenue upon collecting the premium.

Typically, so as to ensure the financial viability of the guarantee program, an account is open by each vehicle dealer for the latter to deposit the second portion of the premium intended to constitute the actuarial reserve. This account in controlled by the administrator of the guarantee program. Advantageously, the processing unit can be programmed to manage and store in the data storage device data pertaining to each of the actuarial reserves of the vehicle dealers.

More specifically, it is possible to envisage:
Transfer of the guarantee from a damaged windshield amongst said plurality of windshields to a new windshield replacing the damage windshield; and
Transfer of the guarantee of a windshield amongst the plurality of windshields from a first owner of the vehicle equipped with the windshield to a second owner of the vehicle.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

What is claimed is:

1. A method for guaranteeing the repair of a damaged windshield through a guarantee program, wherein at least one vehicle dealer participates to the guarantee program and a plurality of windshields are guaranteed by the guarantee program each in exchange of a premium paid by an owner of a vehicle equipped with the windshield, the method inducing the owners of the guaranteed windshields to have repairs made at the at least one participating vehicle dealer, the method comprising:
providing a processing unit having a data storage device associated therewith;
assigning to each of the at least one vehicle dealer a corresponding vehicle dealer identifying code;
for each of the at least one vehicle dealer, storing the corresponding vehicle dealer identifying code in the data storage device;
assigning to each of the plurality of windshields a corresponding windshield identifying code;
for each of the plurality of windshields, storing the corresponding windshield identifying code in the data storage device; and
relating each of the plurality of windshields to a vehicle dealer by relating the corresponding windshield identifying code to a corresponding vehicle dealer identifying code;
whereby the owners of the guaranteed windshields are induced to have guaranteed windshields repaired for free at the at least one participating vehicle dealer, thereby increasing participating vehicle dealer traffic.

2. A method as recited in claim 1, wherein each vehicle equipped with a windshield has a make, and wherein relating each of the plurality of windshields to a vehicle dealer comprises relating each windshield to a vehicle dealer selling vehicles of the same make as the make of the vehicle equipped with the windshield.

3. A method as recited in claim 1, wherein each vehicle equipped with a windshield has a make, and wherein relating each of the plurality of windshields to a vehicle dealer comprises relating each windshield to a vehicle dealer having a technical expertise in the make of the vehicle equipped with the windshield.

4. A method as recited in claim 1, wherein each vehicle equipped with a windshield has a make, and wherein relating each of the plurality of windshields to a vehicle dealer comprises relating each windshield to a vehicle dealer using genuine parts for repairing windshields.

5. A method as recited in claim 1, wherein each vehicle equipped with a windshield has a make, and wherein relating each of the plurality of windshields to a vehicle dealer comprises relating each windshield to the vehicle dealer where the vehicle equipped with the windshield was sold.

6. A method as recited in claim 1, comprising guaranteeing for repair each of the plurality of windshields upon sale of the vehicle equipped with the windshield.

7. A method as recited in claim 1, comprising:
storing in the data storage device windshield casualty data; and
using the processing unit, calculating from the windshield casualty data a premium for guaranteeing a given windshield of the plurality of windshields.

8. A method as recited in claim 7, wherein the windshield casualty data comprises at least one element selected from the group consisting of: type of windshield casualties; rates of occurrence of damages to windshields; nature of damages to windshields; costs for repairing windshields; and combinations thereof.

9. A method as recited in claim 1, wherein the premium is collected by the vehicle dealer related to the windshield.

10. A method as recited in claim 9, wherein the vehicle dealer related to the windshield remits a part of the collected premium to an administrator in counterpart of the administrator's managing the guarantee program.

11. A method as recited in claim 1, comprising paying the premium once throughout the lifetime of the vehicle equipped with the windshield.

12. A method as recited in claim 1, comprising guaranteeing the windshield throughout the lifetime of the vehicle equipped with the windshield.

13. A method as recited in claim 1, comprising allowing transfer of the guarantee from a damaged windshield amongst said plurality of windshields to a new windshield replacing the damage windshield.

14. A method as recited in claim 1, further comprising emitting for each of the plurality of windshields at least one of a guarantee certificate and a sticker for application in the windshield.

15. A method as recited in claim 14, further comprising marking the sticker with the corresponding windshield identifying code.

16. A method as recited in claim 1, wherein relating each of the plurality of windshields to a vehicle dealer comprises relating each windshield to a vehicle dealer where the vehicle equipped with the windshield was sold, said method further comprising including the premium in the price of sale of the vehicle.

17. A method as recited in claim 1, further comprising transferring the guarantee of a windshield amongst the plurality of windshields from a first owner of the vehicle equipped with the windshield to a second owner of the vehicle.

18. A method as recited in claim 1, further comprising:
using the processing unit, calculating for each of the at least one vehicle dealer an actuarial reserve to secure future claims made to the at least one vehicle dealer, in respect to the guarantee program, for windshields related to the at least one vehicle dealer.

19. A method as recited in claim 1, further comprising:
providing each of the at least one vehicle dealer with a terminal; and
linking the terminal to at least one of the processing unit and the data storage device;
whereby, using the terminal, the at least one vehicle dealer can exchange data with said at least one of the processing unit and the data storage device in respect to the guarantee program.

20. A method as recited in claim 1, wherein at least one insurer participates to the guarantee program, further comprising:
assigning to each of the at least one insurer a corresponding insurer identifying code through the processing unit;
for each of the at least one insurer, storing in the data storage device the corresponding insurer identifying code;
for each given windshield amongst the plurality of windshields insured by a participating insurer, using the processing unit to relate the given windshield to the participating insurer by relating the corresponding windshield identifying code to the corresponding insurer identifying code.

21. A method as recited in claim 20, further comprising redirecting a claim to the participating insurer for repairing the given windshield to the vehicle dealer related to the given windshield.

22. A method as recited in claim 20, further comprising:
providing to the at least one insurer a terminal; and
linking the terminal to at least one of the processing unit and the data storage device;
whereby, using the terminal, the at least one insurer can exchange data with the at least one of the processing unit and the data storage device in respect to the guarantee program.

23. A system for guaranteeing the repair of a damaged windshield through a guarantee program, wherein at least one vehicle dealer participates to the guarantee program and a plurality of windshields are guaranteed by the guarantee program each in exchange of a premium paid by an owner of a vehicle equipped with the windshield, the system inducing the owners of the guaranteed windshields to have repairs made at the at least one participating vehicle dealer, the system comprising:
a processing unit so configured as to:
assign to each of the at least one vehicle dealer a corresponding vehicle dealer identifying code;
assign to each of the plurality of windshields a corresponding windshield identifying code; and
relate each windshield to a vehicle dealer by relating the corresponding windshield identifying code to the corresponding vehicle dealer identifying code;
and
a storage device associated with the processing unit, the storage device being so configured as to:
store the corresponding vehicle dealer identifying code for each of the at least one vehicle dealer;
store the corresponding windshield identifying code for each of the plurality of windshields; and
store the relation between the windshield identifying code of each of the plurality of windshields and the corresponding vehicle dealer identifying code of the at least one vehicle dealer;
whereby the owners of guaranteed windshields are induced to have the guaranteed windshields repaired for free at the at least one participating vehicle dealer, thereby increasing participating vehicle dealer traffic.

24. A system as recited in claim 23, wherein each vehicle equipped with a windshield has a make, and wherein the processing unit is so configured as to relate each windshield to a vehicle dealer selling vehicles of the same make as the make of the vehicle equipped with the windshield.

25. A system as recited in claim 23, wherein each vehicle equipped with a windshield has a make, and wherein the processing unit is so configured as to relate each windshield to a vehicle dealer having a technical expertise in the make of the vehicle equipped with the windshield.

26. A system as recited in claim 23, wherein each vehicle equipped with a windshield has a make, and wherein the processing unit is so configured as to relate each windshield to a vehicle dealer using genuine parts for repairing windshields.

27. A system as recited in claim 23, wherein each vehicle equipped with a windshield has a make, and wherein the processing unit is so configured as to relate each windshield to the vehicle dealer where the vehicle equipped with the windshield was sold.

28. A system as recited in claim 23, wherein:
the storage device is so configured as to store in the data storage device windshield casualty data; and
the processing unit is so configured as to calculate from the stored windshield casualty data a premium for guaranteeing a given windshield of the plurality of windshields.

29. A system as recited in claim 28, wherein the windshield casualty data comprises at least one element selected from the group consisting of: type of windshield casualties; rates of occurrence of damages to windshields; nature of damages to windshields; costs for repairing windshields; and combinations thereof.

30. A system as recited in claim 23, further comprising, for each of the plurality of windshields, at least one of a guarantee certificate and a sticker for application in the windshield.

31. A system as recited in claim 30, wherein the sticker is marked with the corresponding windshield identifying code.

32. A system as recited in claim 23, wherein the processing unit is so configured as to calculate for each of the at least one vehicle dealer an actuarial reserve to secure future claims made to the at least one vehicle dealer, in respect to the guarantee program, for windshields related to the at least one vehicle dealer.

33. A system as recited in claim 23, further comprising:
a terminal provided to each of the at least one vehicle dealer; and
a link between the terminal and at least one of the processing unit and the data storage device;
whereby, using the terminal, the at least one vehicle dealer can exchange data with said at least one of the processing unit and the data storage device in respect to the guarantee program.

34. A system as recited in claim 23, wherein:
at least one insurer participates to the guarantee program;
the processing unit is so configured as to assign to each of the at least one insurer a corresponding insurer identifying code;
the data storage device is so configured as to store the corresponding insurer identifying code;
for each given windshield amongst the plurality of windshields, insured by a participating insurer, the processing unit is so configured as to relate the given windshield to the participating insurer by relating the corresponding windshield identifying code to the corresponding insurer identifying code.

35. A method as recited in claim 34, further comprising:
a terminal provided to the at least one insurer; and
a link between the terminal to at least one of the processing unit and the data storage device;
whereby, using the terminal, the at least one insurer can exchange data with the at least one of the processing unit and the data storage device in respect to the guarantee program.

36. A method for guaranteeing the repair of a damaged windshield through a guarantee program, wherein a plurality of windshields are guaranteed by the guarantee program each in exchange of a premium paid by an owner of a vehicle equipped with the windshield, the method comprising:
providing a processing unit having a data storage device associated therewith;
assigning to each of the plurality of windshields a corresponding windshield identifying code;
for each of the plurality of windshields, storing the corresponding windshield identifying code in the data storage device;
storing in the data storage device serial numbers of the vehicles equipped with said plurality of windshields; and
relating each of the plurality of windshields to the vehicle equipped with said windshield by relating the windshield identifying code of said windshield to the serial number of the vehicle equipped with said windshield;
whereby upon repairing a damaged windshield, the guarantee of the damaged windshield being repaired can be validated through validation of the serial number of the vehicle equipped with said damaged windshield.

37. A system for guaranteeing the repair of a damaged windshield through a guarantee program, wherein a plurality of windshields are guaranteed by the guarantee program each in exchange of a premium paid by an owner of a vehicle equipped with the windshield, the system comprising:
a processing unit so configured as to:
assign to each of the plurality of windshields a corresponding windshield identifying code;
relate each of the plurality of windshields to the vehicle equipped with said windshield by relating the windshield identifying code of said windshield to a serial number of the vehicle equipped with said windshield; and
a storage device associated with the processing unit, the storage device being so configured as to:
store the windshield identifying codes of the plurality of windshields;
store serial numbers of the vehicles equipped with said plurality of windshields; and
store the relation between the windshield identifying code of each of the plurality of windshields and the serial number of the vehicle equipped with said windshield;
whereby upon repairing a damaged windshield, the guarantee of the damaged windshield being repaired can be validated through validation of the serial number of the vehicle equipped with said damaged windshield.
